(19) United States
(12) Patent Application Publication
(10) Pub. No.: US 2009/0147146 A1
(43) Pub. Date: Jun. 11, 2009

(54) METHOD AND APPARATUS FOR REPRODUCING MEDIA CONTENT OF PORTABLE DEVICE VIA DIGITAL TELEVISION

(76) Inventors: Jin-young LEE, Seoul (KR); Kyong-joon CHUN, Seoul (KR)

Correspondence Address: STEIN MCEWEN, LLP, 1400 EYE STREET, NW, SUITE 300, WASHINGTON, DC, 20005, US

(21) Appl. No.: 12/330,970

(22) Filed: Dec. 9, 2008

(30) Foreign Application Priority Data
Dec. 11, 2007 (KR) 2007-128184

(51) Int. Cl. H04N 5/44

(52) U.S. Cl. 348/725; 348/E05.096

(57) ABSTRACT

A digital TV connected to a portable device via an external input port. The digital TV to which the portable device is connected recognizes the type of the portable device, downloads media content stored in the portable device, and reproduces the media content via a screen and/or a speaker of the digital TV, so that a user can easily view the media content of the portable device via the digital TV without having to perform complex manipulations.

### CROSS-REFERENCE TO RELATED APPLICATION

This application claims the benefit of Korean Patent Application No. 2007-128184 filed in the Korean Intellectual Property Office on Dec. 11, 2007, the disclosure of which is incorporated herein by reference.

### BACKGROUND OF THE INVENTION

1. Field of the Invention

Aspects of the present invention relate to a digital television (TV), and more particularly, to a method of reproducing media content of a portable device via a digital TV that interacts with the portable device.

2. Description of the Related Art

The more mobile digital content increases, the more digital convergence accelerates, and thus portable devices have original functions and various additional functions as well. For example, many cellular phones that have been released in recent times function as digital cameras and digital camcorders. Moreover, portable multimedia players (PMPs) can receive and record digital broadcasting.

Such multifunctional portable devices that are used to reproduce or create media content have more complex user interfaces. Therefore, it would be difficult for users who are not accustomed to portable devices to search for and reproduce media content stored in portable devices. Portable devices do not provide even those users who are accustomed to portable devices with good conditions to view media content due to a limited battery capacity or a limited screen size of the portable devices.

It is possible to edit or reproduce media content created by portable devices in another digital device owing to characteristics of digital data. For example, since it is inconvenient to view digital photos or video taken by cellular phones via small screens of cellular phones, users generally view digital content stored in cellular phones via digital TVs having large screens.

FIG. 1 is a flowchart of a conventional process necessary for reproducing media content of a portable device via a digital TV. Referring to FIG. 1, a user turns on the digital TV in operation 110. The user connects the digital TV to the portable device via an external input port, such as a universal serial bus (USB) in operation 120. The user changes an output mode of the digital TV into a mode for the external input port connected to a portable memory by using a remote controller in operation 130.

The user selects media content that the user desires to reproduce from a directory structure of the portable memory by using the remote controller in operation 140. Generally, if the portable device is connected to the digital TV via the USB port, since the digital TV recognizes the portable device as a mass storage device, the user designates media content in person. The digital TV reproduces the media content selected by the user in operation 150.

According to the conventional art, the user must control an output mode of a digital TV when reproducing media content of a portable device via the digital TV, search for a directory of a portable memory by using a remote controller, and designate the media content to be reproduced.

### SUMMARY OF THE INVENTION

Aspects of the present invention provide a digital TV that automatically reproduces media content stored in a portable device when the digital TV is connected to the portable device without the necessity of a user's intervention and a method of reproducing the media content stored in the portable device via the digital TV.

According to an aspect of the present invention, a method of processing data of a portable device by using a digital TV is provided. The method comprises changing an output mode to an output mode for an external input port upon detecting that the portable device is connected to the digital TV via the external input port; and reproducing at least one item of media content stored in the portable device if the output mode is changed.

According to another aspect of the present invention, the changing of the output mode comprises requesting the portable device to identify a type of the portable device; and selectively changing the output mode to the output mode for the external input port based on a response to the request.

According to another aspect of the present invention, the reproducing of the at least one item of media content comprises requesting the portable device to send the at least one item of media content; storing the at least one item of media content received according to the request; and decoding the stored at least one item of media content.

According to another aspect of the present invention, the reproducing of the at least one item of media content further comprises selecting at least one item of media content from among media content stored in the portable device according to a predetermined reference; and reproducing the selected at least one item of media content.

According to another aspect of the present invention, the predetermined reference comprises at least one of a creation sequence, capacity, number, and format of media content.

According to another aspect of the present invention, the method further comprises controlling a function provided by the portable device according to an input signal from the portable device or a wireless input device for the digital TV, and displaying a screen of the portable device via a screen of the digital TV when controlling the function provided by the portable device.

According to another aspect of the present invention, the wireless input device comprises at least one of a remote controller, a wireless mouse, and a wireless keyboard.

According to another aspect of the present invention, the changing of the output mode may further comprise: turning on the digital TV if the digital TV is turned off before the portable device is connected to the digital TV.

According to another aspect of the present invention, the method further comprises returning to an output mode in which the digital TV was operating before the portable device was connected to the digital TV, if the portable device is disconnected from the digital TV.

According to another aspect of the present invention, the returning to the output mode comprises turning off the digital TV if the digital TV was turned off before the portable device was connected to the digital TV.

According to another aspect of the present invention, the method further comprises connecting to a remote server via the portable device and upgrading firmware of the digital TV.

According to another aspect of the present invention, the wireless input port is a universal serial bus (USB).

According to another aspect of the present invention, the portable device is wirelessly connected to the digital TV via the wireless input port.

According to another aspect of the present invention, the method further comprises notifying a user via an output device of the digital TV that one of a short message service (SMS), an e-mail, and a call are received by using the portable device while the digital TV reproduces the media content.

According to another aspect of the present invention, there is provided a digital TV, comprising: a changing unit to change an output mode to an output mode for an external input port upon detecting that the portable device is connected to the digital TV via the external input port; and a reproducing unit reproducing at least one item of media content stored in the portable device if the output mode is changed.

According to another aspect of the present invention, there is provided a computer readable medium having recorded thereon a computer program to executing the method.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a flowchart of a conventional process to reproduce media content of a portable device via a digital TV;

FIG. 2 is a flowchart of a process of reproducing media content of a portable device by using a digital TV according to an embodiment of the present invention;

FIG. 3 is a flowchart of a process of operating a digital TV when a portable device is disconnected from the digital TV according to an embodiment of the present invention;

FIG. 4 illustrates a menu displayed on a screen of a digital TV according to an embodiment of the present invention;

FIG. 5 is a flowchart of a process of controlling a portable device by using a digital TV according to an embodiment of the present invention;

FIG. 6 is a flowchart of a process of upgrading firmware of a digital TV via a portable device according to an embodiment of the present invention; and

FIG. 7 is a block diagram of a digital TV according to an embodiment of the present invention.

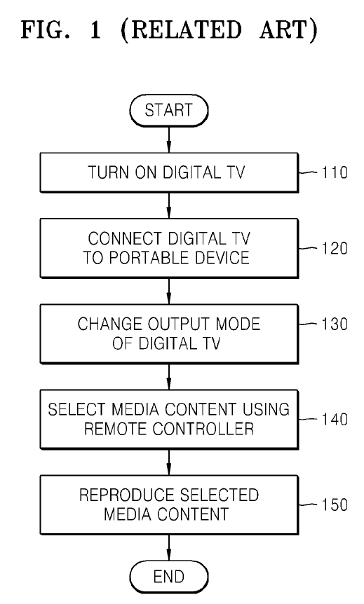

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

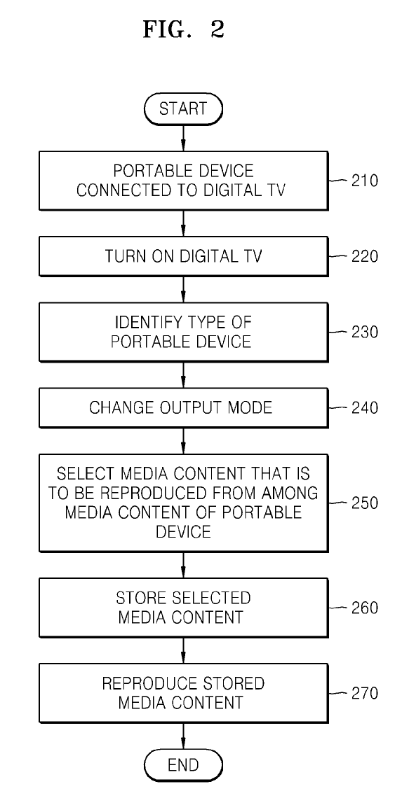

FIG. 2 is a flowchart of a process of reproducing media content of a portable device by using a digital TV according to an embodiment of the present invention. The portable device may be any portable devices capable of automatically reproducing media content stored therein via the digital TV. The portable device may be, for example, a cellular phone, a personal digital assistant (PDA), a personal entertainment device, or a portable multimedia player. Whether the digital TV automatically reproduces media content may be determined by a user, or at the time when the digital TV or the portable device is released by a manufacturer. Although not required in all aspects of the present invention, it is assumed herein that the digital TV automatically reproduces the media content of the portable device when the portable device is a cellular phone.

Referring to FIG. 2, the portable device is connected to the digital TV via a predetermined external port, such as a universal serial bus (USB) port, in operation 210. The portable device and the digital TV may be connected via a wired or wireless connection. For example, the portable device and the digital TV may be connected to each other by connecting a dongle to the portable device. The digital TV may also charge the portable device while the portable device is connected to the digital TV.

If the connection between the portable device and the digital TV via the external port is recognized, the digital TV is turned on in operation 220. The portable device and the digital TV identify each other's type according to a predetermined communication protocol in operation 230. The digital TV recognizes the portable device as a communication device that receives and transmits messages using a communication protocol, instead of as a passive portable storage device. The specification of the communication protocol is not defined herein, but may be any communication protocol to enable communication between different devices. If the digital TV identifies the type of the portable device connected thereto as a cellular phone, the digital TV changes a port mode into an output mode for the external port without a user's input in operation 240.

The digital TV selects media content that is to be reproduced according to a predetermined reference from among media content of the portable device in operation 250. In this regard, the selection reference may be a creation sequence, capacity, number, format of media content, or the like. The user can previously designate a reference for selecting a media file. For example, the user may designate the reference to select JPG media files that are created within one week of a current date, from among media content stored in the cellular phone in a range of 100 Mbytes.

The digital TV requests the portable device for the selected media content and stores the selected media content transmitted by the portable device in a memory of the digital TV in operation 260. The user can view media content via the digital TV after the portable device is disconnected from the digital TV by storing the media content of the portable device in the digital TV.

The digital TV decodes and reproduces the media content stored in the memory in operation 270. If the portable device receives a short message service (SMS), an e-mail, a call, or the like while the digital TV reproduces the media content, the digital TV notifies the user of the receipt through a screen and/or a speaker thereof. According to the above process, the user can view the media content via the digital TV without any additional manipulation, if the portable device is connected to the digital TV.

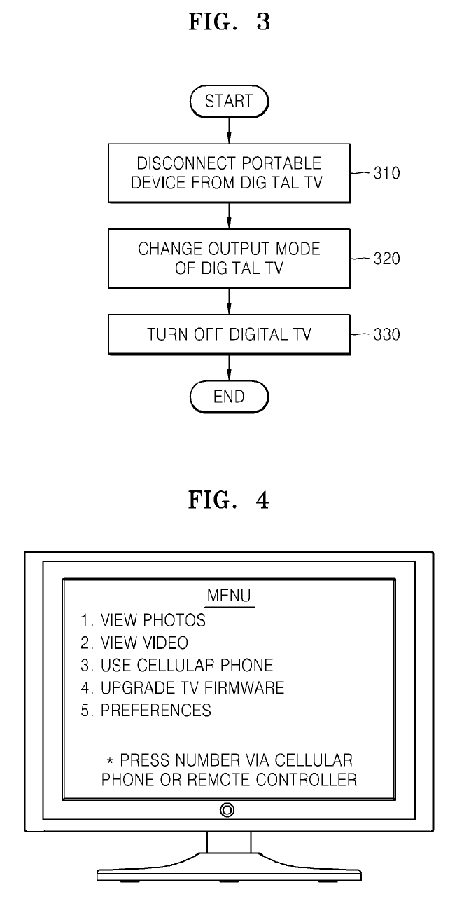

FIG. 3 is a flowchart of a process of operating a digital TV when a portable device is disconnected from the digital TV according to an embodiment of the present invention. First, the portable device is disconnected from the digital TV, which is recognized by the digital TV in operation 310.

In operation 320, the digital TV returns to an original operation state (e.g., an original output mode) before the portable device was connected to the digital TV. For example, if an output mode is an external input 1 before the portable device is connected to the digital TV, the digital TV changes the output mode to the external input 1 after the portable device is disconnected from the digital TV. If the digital TV is turned off before the portable device is connected to the digital TV, the digital TV is turned off in operation 330.

FIG. 4 shows a menu displayed on a screen of a digital TV according to an embodiment of the present invention. In the present embodiment, a portable device is a cellular phone. If a user connects the cellular phone to the digital TV, and selects a menu display via a wireless input device for the digital TV, the digital TV displays the menu on the screen thereof. The wireless input device may be, for example, a remote controller, a wireless mouse, a wireless keyboard, a wireless microphone, or the like.

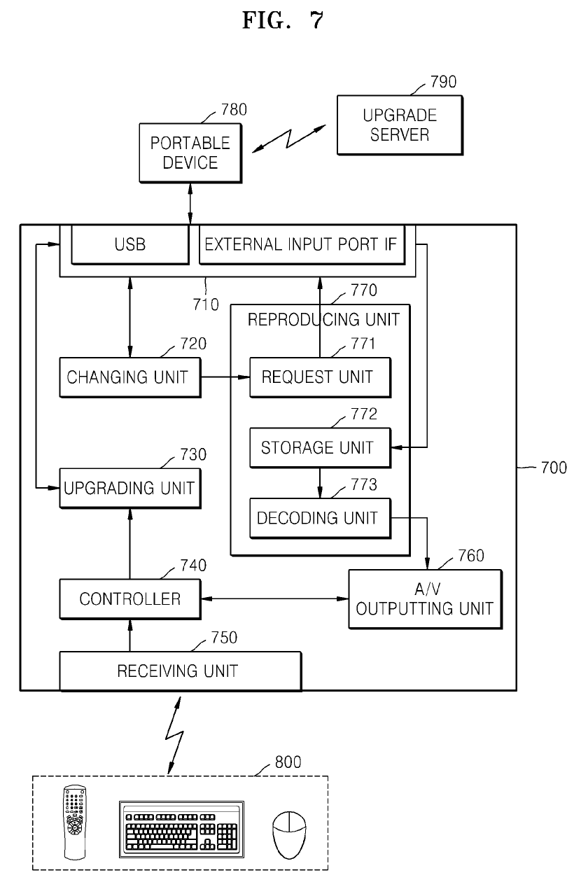

When the menu is displayed on the screen of the digital TV, the user can select a desired item via the wireless input device or a user interface of the cellular phone. If the user selects items 1 and 2, the user can view a photo or video stored in the cellular phone via the screen of the digital TV. A detailed explanation of a user's selection of items 3 and 4 will be provided later with reference to FIGS. 6 and 7.

If the user selects an item 5, the user can establish a variety of environments of the digital TV. For example, when the portable device is connected to the digital TV, it is possible to determine whether to automatically reproduce media content of the portable device. Furthermore, it is possible to determine whether to select media content that is automatically reproduced, to repeat reproduction of the media content, and the like.

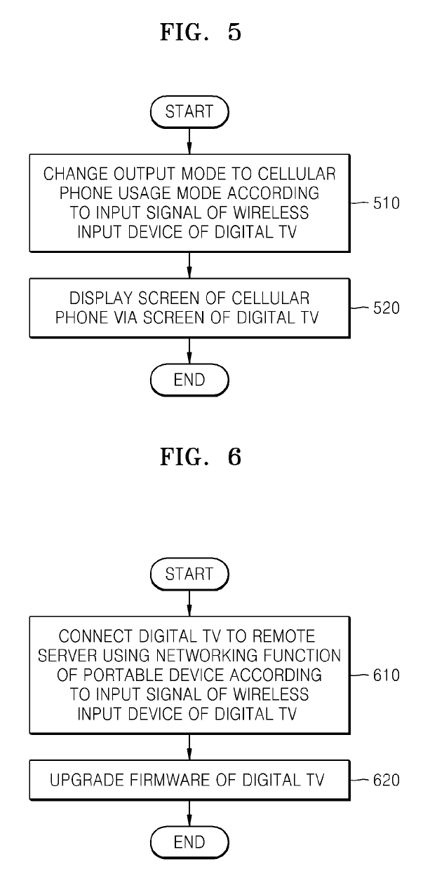

FIG. 5 is a flowchart of a process of controlling a portable device by using a digital TV according to an embodiment of the present invention. In the present embodiment, the portable device is a cellular phone.

If a user performs a specific input via a wireless input device or selects an item 3 from the menu shown in FIG. 4, the digital TV changes an output mode to a cellular phone usage mode in operation 510. Since a mode of the digital TV is changed to the cellular phone usage mode, a screen of the cellular phone is displayed via a screen of the digital TV and a sound of the cellular phone is output via a speaker of the digital TV in operation 520. Furthermore, a user can control the cellular phone via the wireless input device for the digital TV. For example, the user can call using a wireless keyboard and use a video call function provided by the cellular phone by using the screen of the digital TV and a wireless microphone. Furthermore, the user can enjoy a game provided by the cellular phone.

FIG. 6 is a flowchart of a process of upgrading firmware of a digital TV via a portable device according to an embodiment of the present invention. In the present embodiment, the portable device is a cellular phone. Referring to FIG. 6, if a user transmits an instruction to upgrade firmware of the digital TV via a wireless input device, the digital TV controls the cellular phone and is connected to a remote server in operation 610. The digital TV upgrades the firmware by using data received from the remote server in operation 620.

According to the conventional art, the digital TV is sent to the manufacturer, or staff of the manufacturer visit a user's home in order to upgrade the firmware of the digital TV. However, the above process according to aspects of the present invention makes it possible for the user to upgrade the firmware of the digital TV in his or her home without requiring a visit from staff of the manufacturer.

FIG. 7 is a block diagram of a digital TV 700 according to an embodiment of the present invention. The digital TV 700 comprises an external input port 710, a changing unit 720, an upgrading unit 730, a controller 740, a receiving unit 750, an A/V outputting unit 760, and a reproducing unit 770. According to other aspects of the present invention, the digital TV 700 may include additional and/or different components. Similarly, the functionality of two or more of the above units may be integrated into a single component.

The external input port 710 is an interface connecting the digital TV 700 and a portable device 780, and may include various types of devices including a USB, a wireless LAN card, and the like. The external input port is an example of a communication unit to connect to the portable device 780, and may support any type of wired or wireless communication protocol, such as USB, IEEE 1394 (FireWire), Bluetooth, or Wi-Fi.

If the portable device 780 is connected to the digital TV 700 via the external input port 710, the changing unit 720 identifies a type of the portable device 780 via a message exchange between the changing unit 720 and the portable device 780. If the portable device 780 is a predetermined specific type of device, the changing unit 720 changes an output mode of the digital TV 700 to that for the external input port 710. If the user requests a firmware upgrade via a wireless input device 800, the upgrading unit 730 upgrades firmware of the digital TV 700 by using data received from a remote upgrade server 790 via the portable device 780.

The controller 740 controls a function provided by the portable device 780 according to a user's input signal via the wireless input device 800, and outputs a screen of a cellular phone via a display device of the digital TV 700, i.e., the AN outputting unit 760, when using the function provided by the portable device 780. Furthermore, the controller 740 can output a sound of the cellular phone via a speaker of the digital TV 700, i.e. the AN outputting unit 760.

If the portable device 780 receives an e-mail, an SMS, a call, or the like, while the reproducing unit 770 of the digital TV 700 reproduces media content of the portable device 780, the controller 740 notifies the user of the receipt through the A/V outputting unit 760. The receiving unit 750 receives a signal transmitted by the user via the wireless input device 800 for the digital TV 700.

If a specific type of portable device 780 is connected to the digital TV 700, the reproducing unit 770 selects and reproduces at least one item of media content from among pieces of media content stored in the portable device 780 according to a predetermined reference. The selection reference may be a creation sequence, capacity, number, format of media content, or the like.

The reproducing unit 770 comprises a request unit 771, a storage unit 772, and a decoding unit 773. The request unit 771 requests the portable device 780 to send at least one item of media content that is to be reproduced. The storage unit 772 stores the media content transmitted by the portable device 780 according to the request of the request unit 771. The decoding unit 773 decodes the media content stored in the storage unit 772 and outputs the decoded media content through the A/V outputting unit 760, e.g., an LCD panel and/or a speaker.

Aspects of the present invention can also be embodied as computer readable code on a computer readable recording medium. The computer readable recording medium is any data storage device that can store data which can be thereafter read by a computer system.

Examples of the computer readable recording medium include read-only memory (ROM), random-access memory (RAM), CDs, DVDs, Blu-ray discs, magnetic tapes, floppy disks, and optical data storage devices.

According to aspects of the present invention, a user can view media content stored in a portable device merely by connecting a digital TV to the portable device without having to manipulate the portable device or the digital TV. Furthermore, the user can use a variety of functions provided by the portable device via a user interface of the digital TV.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A method of processing data of a portable device by using a digital TV, the method comprising:
changing an output mode to an output mode for an external input port upon detecting that the portable device is connected to the digital TV via the external input port; and
reproducing at least one item of media content stored in the portable device if the output mode is changed.

2. The method of claim 1, wherein the changing of the output mode comprises:
requesting the portable device to identify a type of the portable device; and
selectively changing the output mode to the output mode for the external input port based on a response to the request.

3. The method of claim 1, wherein the reproducing of the at least one item of media content comprises:
requesting the portable device to send the at least one item of media content;
storing the at least one item of media content received according to the request; and
decoding the stored at least one item of media content.

4. The method of claim 3, wherein the reproducing of the at least one item of media content further comprises:
selecting at least one item of media content from among media content stored in the portable device according to a predetermined reference; and
reproducing the selected at least one item of media content.

5. The method of claim 4, wherein the predetermined reference comprises at least one of a creation sequence, capacity, number, and format of media content.

6. The method of claim 1, further comprising:
controlling a function provided by the portable device according to an input signal from the portable device or a wireless input device for the digital TV; and
displaying a screen of the portable device via a screen of the digital TV when controlling the function provided by the portable device.

7. The method of claim 6, wherein the wireless input device comprises at least one of a remote controller, a wireless mouse, and a wireless keyboard.

8. The method of claim 1, wherein the changing of the output mode further comprises:
turning on the digital TV if the digital TV is turned off before the portable device is connected to the digital TV.

9. The method of claim 1, further comprising:
returning to an output mode in which the digital TV was operating before the portable device was connected to the digital TV, if the portable device is disconnected from the digital TV.

10. The method of claim 9, wherein the returning to the output mode comprises: turning off the digital TV if the digital TV was turned off before the portable device was connected to the digital TV.

11. The method of claim 1, further comprising:
connecting to a remote server via the portable device and upgrading firmware of the digital TV.

12. The method of claim 1, wherein the wireless input port is a universal serial bus (US B).

13. The method of claim 1, wherein the portable device is wirelessly connected to the digital TV via the wireless input port.

14. The method of claim 1, further comprising:
notifying a user via an output device of the digital TV that one of a short message service (SMS), an e-mail, and a call are received by using the portable device while the digital TV reproduces the media content.

15. A digital TV comprising:
a changing unit to change an output mode to an output mode for an external input port upon detecting that the portable device is connected to the digital TV via the external input port; and
a reproducing unit to reproduce at least one item of media content stored in the portable device if the output mode is changed.

16. The digital TV of claim 15, wherein the changing unit requests the portable device to identify a type of the portable device, and selectively changes the output mode to the output mode for the external input port based on a response to the request.

17. The digital TV of claim 15, wherein the reproducing unit comprises:
a requesting unit to request the portable device to send the at least one item of media content;
a storage unit to store the at least one item of media content received according to the request; and
a decoding unit to decode the stored at least one item of media content.

18. The digital TV of claim 15, wherein the reproducing unit selects at least one item of media content to be reproduced from among media content stored in the portable device according to a predetermined reference.

19. The digital TV of claim 18, wherein the predetermined reference comprises at least one of a creation sequence, capacity, number, and format of media content.

20. The digital TV of claim 15, further comprising:
a controller to control a function provided by the portable device, according to an input signal from the portable device or a wireless input device, for the digital TV, and to display a screen of the portable device via a screen of the digital TV when controlling the function provided by the portable device.

21. The digital TV of claim 20, wherein the wireless input device comprises at least one of a remote controller, a wireless mouse, and a wireless keyboard.

22. The digital TV of claim 15, wherein the changing unit turns on the digital TV when the digital TV is turned off before the portable device is connected to the digital TV.

23. The digital TV of claim 15, wherein the changing unit returns to an output mode in which the digital TV was operating before the portable device is connected to the digital TV if the portable device is disconnected from the digital TV.

24. The digital TV of claim 23, wherein the changing unit turns off the digital TV if the digital TV was turned off before the portable device was connected to the digital TV.

25. The digital TV of claim 15, further comprising:
an upgrading unit to connect to a remote server via the portable device and to upgrade firmware of the digital TV.

26. The digital TV of claim 15, wherein the wireless input port is a Universal Serial Bus (USB).

27. The digital TV of claim 15, wherein the portable device is wirelessly connected to the digital TV via the wireless input port.

28. The digital TV of claim 20, wherein the controller notifies a user via an output device of the digital TV that one of an SMS, an e-mail, and a call are received by using the portable device while the digital TV reproduces the media content.

29. A computer readable medium having recorded thereon a computer program to execute the method of claim 1.

30. A digital television comprising:
a communication unit to connect to a portable device via a wired or wireless communication protocol;
a changing unit to change an output mode of the digital television to an output mode of the communication unit upon determining that the portable device is connected to the digital television via the communication unit; and
a reproducing unit to reproduce at least one item of media content stored on the portable device if the changing unit changes the output mode.

31. The digital television of claim 30, wherein, when the changing unit determines that the portable device is disconnected from the digital television, the changing unit changes the output mode of the digital television to an output mode in which the digital television was operating prior to the connection of the portable device to the digital television.

32. The digital television of claim 30, wherein, when the changing unit determines that the portable device is connected to the digital television, the changing unit turns on the digital television and changes the digital television to the output mode of the communication unit.

33. The digital television of claim 30, wherein, when the changing unit determines that the portable device is disconnected from the digital television, and the digital television was turned off prior to the connection of the portable device to the digital television, the changing unit turns off the digital television.

34. A method of operating a digital television comprising:
determining that a portable device is connected to the digital television via a communication unit that supports a wired or wireless communication protocol;
changing an output mode of the digital television to an output mode of the communication unit; and
accessing the portable device via the digital television.

35. The method of claim 34, wherein the accessing of the portable device comprises reproducing an item of media content stored on the portable device.

36. The method of claim 34, further comprising:
determining that the portable device is disconnected from the digital television; and
changing the output mode of the digital television to an output mode in which the digital television was operating prior to determining that the portable device was connected to the digital television.

37. The method of claim 34, further comprising:
after determining that the portable device is connected to the digital television, turning on the digital television.

38. The method of claim 34, further comprising:
determining that the portable device is disconnected from the digital television; and
if the digital television was turned off prior to determining that the portable device was connected to the digital television, turning off the digital television.
